(19) United States
(12) Patent Application Publication
(10) Pub. No.: US 2021/0111429 A1
(43) Pub. Date: Apr. 15, 2021

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Hiroshi Minami, Osaka (JP); Yuta Seki, Osaka (JP)

(73) Assignee: Panasonic Intellectual Property Management Co., Ltd., Osaka-shi, Osaka (JP)

(21) Appl. No.: 16/496,556

(22) PCT Filed: Jan. 29, 2018
(86) PCT No.: PCT/JP2018/002743

§ 371 Date: Sep. 23, 2019

(30) Foreign Application Priority Data
Mar. 28, 2017 (JP) 2017-062569

(51) Int. Cl. H01M 10/0563; H01M 4/66; H01M 10/0525

(52) U.S. Cl. CPC H01M 10/0563; H01M 2004/027; H01M 10/0525; H01M 4/661

(57) ABSTRACT

A non-aqueous electrolyte secondary battery is equipped with: a positive electrode provided with a positive electrode current collector and a positive electrode mixed material layer formed on the current collector; a negative electrode provided with a negative electrode current collector; and a non-aqueous electrolyte. A lithium secondary battery which is configured so that metal lithium is deposited on a negative electrode current collector during charging and the metal lithium is dissolved in a non-aqueous electrolyte during discharging. The non-aqueous electrolyte contains a lithium salt for which the anion is an oxalate complex.

### TECHNICAL FIELD

The present disclosure relates to a non-aqueous electrolyte secondary battery, and in more detail to a lithium secondary battery.

### BACKGROUND ART

A larger capacity is demanded of non-aqueous electrolyte secondary batteries not only in the ICT field such as personal computers and smart phones but also in the vehicle installation field, the electricity storage field, and the like. As a large-capacity non-aqueous electrolyte secondary battery, a lithium ion battery is used exclusively. In the lithium ion battery, the large capacity has been achieved by, for example, combining graphite and an alloy active material such as a silicon compound to use as a negative electrode active material, but the capacity has nearly reached its limit.

As a non-aqueous electrolyte secondary battery that surpasses a lithium ion battery, a lithium secondary battery wherein a lithium metal is deposited on the negative electrode during charging and the lithium metal is dissolved into the non-aqueous electrolyte during discharging is promising. For example, Patent Literature 1 discloses a lithium secondary battery in which a ten-point average roughness (Rz), which is defined in JIS B0601, at the lithium metal deposition side of the negative electrode current collector is 10 μm or less.

### CITATION LIST

### Patent Literature

PATENT LITERATURE 1: Japanese Unexamined Patent Application Publication No. 2001-243957

### SUMMARY

A lithium secondary battery has a problem that lithium metal dendrites are produced during charging to lower the safety or increase side reactions. The technique disclosed in Patent Literature 1 suppresses the production of the lithium metal dendrites but has still room for improvement. Further, in a lithium secondary battery, the amount of expansion of the negative electrode during charging is large, so that in a cylindrical battery, the electrode may be cut by the influence of the stress generated due to the expansion of the negative electrode. In addition, a rectangular battery or a laminate battery has a problem that the thickness of the battery is considerably increased due to the expansion of the negative electrode.

A non-aqueous electrolyte secondary battery that is one aspect of the present disclosure, comprises: a positive electrode having a positive electrode current collector and a positive electrode mixture layer formed on the collector; a negative electrode having a negative electrode current collector; and a non-aqueous electrolyte, wherein a lithium metal is deposited on the negative electrode current collector during charging and the lithium metal is dissolved into the non-aqueous electrolyte during discharging, and wherein the non-aqueous electrolyte contains a lithium salt containing an oxalate complex as an anion.

According to one aspect of the present disclosure, a non-aqueous electrolyte secondary battery (lithium secondary battery) in which lithium metal dendrites are unlikely to be produced dining charging, and the expansion of the negative electrode is suppressed may be provided. According to a lithium secondary battery that is one aspect of the present disclosure, the safety is high, and a favorable cycle characteristics is obtained.

### BRIEF DESCRIPTION OF DRAWING

FIG. 1 is a sectional view of a non-aqueous electrolyte secondary battery as one exemplary embodiment.

### DESCRIPTION OF EMBODIMENTS

As described above, a large capacity that surpasses the capacity of a lithium ion battery can be expected of the non-aqueous electrolyte secondary battery (lithium secondary battery) depositing lithium metal on the negative electrode during charging and dissolving the lithium metal into the non-aqueous electrolyte during discharging, but such a non-aqueous electrolyte secondary battery has problems that lithium metal dendrites are likely to be produced and that the amount of expansion of the negative electrode is large.

As a result of earnest studies in order to solve the problems, the present inventors have found that when a lithium salt containing an oxalate complex as an anion is added to a non-aqueous electrolyte, lithium metal is thereby deposited uniformly on the negative electrode, so that the expansion of the negative electrode is suppressed specifically.

A film called an SEI (Solid Electrolyte Interphase) film is formed on the surface of the negative electrode due to decomposition of electrolyte components, and the SEI film is also formed on the surface of the deposited lithium metal, but the thickness of this film is nonuniform, and therefore it is conceivable that the lithium metal is deposited in the form of a dendrite. In contrast, it is conceivable that the lithium salt containing an oxalate complex as an anion, when decomposed on the negative electrode, covers the surface of the lithium metal thinly and uniformly. It is conceivable that the lithium salt is decomposed at a higher potential than the other additives and solvents contained in the non-aqueous electrolyte to form a thin, uniform SEI film on the surface of the deposited lithium metal.

Therefore, the lithium metal is likely to be deposited uniformly on the negative electrode and the expansion of the negative electrode is suppressed considerably. According to one aspect of the present disclosure, in the lithium secondary battery using a wound type electrode assembly, cutting of the electrode due to the expansion of the negative electrode can be sufficiently suppressed, and in a lithium secondary battery using a laminate type electrode assembly, expansion of the battery can be significantly suppressed.

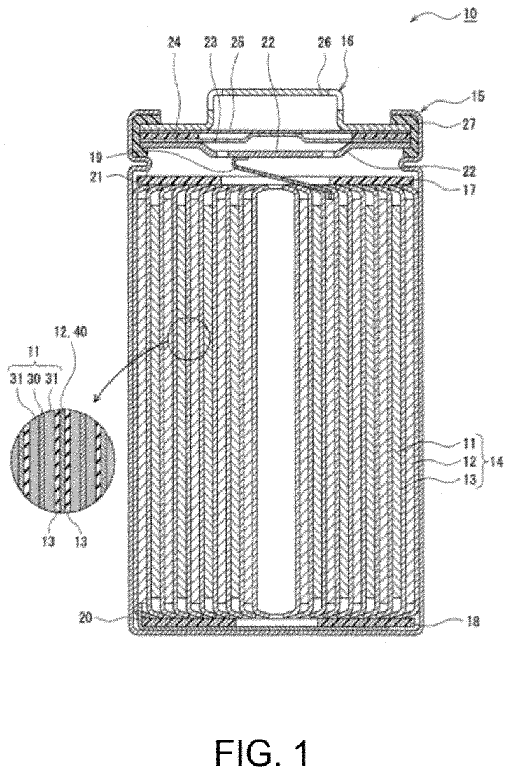

Hereinafter, exemplary embodiments of a non-aqueous electrolyte secondary battery of the present disclosure will be described in detail. FIG. 1 is a sectional view of a non-aqueous electrolyte secondary battery 10 as one example of the embodiments.

The non-aqueous electrolyte secondary battery 10 exemplified as an embodiment is a cylindrical battery including a cylindrical metal case, but the non-aqueous electrolyte secondary battery of the present disclosure is not limited to this. The non-aqueous electrolyte secondary battery of the present disclosure may be, for example, a rectangular battery including a rectangular metal case or a laminate battery including an exterior body formed of an aluminum laminate sheet or the like. As an electrode assembly included in the non-aqueous electrolyte secondary battery, a wound type electrode assembly 14 in which a positive electrode and a negative electrode are wound with a separator interposed therebetween is exemplified, but the electrode assembly is not limited to this. The electrode assembly may be, for example, a lamination type electrode assembly in which a plurality of positive electrodes and a plurality of negative electrodes are wound alternately with separators interposed therebetween.

As exemplified in FIG. 1, the non-aqueous electrolyte secondary battery 10 includes the electrode assembly 14 having a wound structure; and a non-aqueous electrolyte (not shown). The electrode assembly 14 has a positive electrode 11, a negative electrode 12, and a separator 13, and the positive electrode 11 and the negative electrode 12 are wound spirally through the separator 13. The non-aqueous electrolyte secondary battery 10 is a lithium secondary battery wherein a lithium metal is deposited on the negative electrode 12 during charging and the lithium metal is dissolved into the non-aqueous electrolyte during discharging. Details will be described later, and the non-aqueous electrolyte preferably contains: a lithium salt containing an oxalate complex as an anion; and lithium hexafluorophosphate (LiPF₆).

The positive electrode 11, the negative electrode 12, and the separator 13 each included in the electrode assembly 14 are each formed into a belt-like shape and wound spirally, to be thereby alternately laminated in the radial direction of the electrode assembly 14. In the electrode assembly 14, the longitudinal direction of each electrode is the wound direction, and the width direction of each electrode is the axial direction. A positive electrode lead 19 electrically connecting the positive electrode 11 and a positive electrode terminal is connected to, for example, the central part of the positive electrode 11 in the longitudinal direction and extends from the upper end of the electrode group. A negative electrode lead 20 electrically connecting the negative electrode 12 and a negative electrode terminal is connected to, for example, the end part of the negative electrode 12 in the longitudinal direction and extends from the lower end of the electrode group.

In the example shown in FIG. 1, a metal battery case housing the electrode assembly 14 and the non-aqueous electrolyte is configured by a case main body 15 and a sealing body 16. Insulating plates 17, 18 are provided on and under the electrode assembly 14 respectively. The positive electrode lead 19 extends on the side of the sealing body 16 through a through-hole of the insulating plate 17 and is welded to the underside of a filter 22 that is a bottom plate of the sealing body 16. In the non-aqueous electrolyte secondary battery 10, a cap 26 of the sealing body 16 electrically connected to the filter 22 is the positive electrode terminal. On the other hand, the negative electrode lead 20 extends on the side of the bottom part of the case main body 15 and is welded to the inner face of the bottom part of the case main body 15. In the non-aqueous electrolyte secondary battery 10, the case main body 15 is the negative electrode terminal.

The case main body 15 is a metal container having a bottomed cylindrical shape. A gasket 27 is provided between the case main body 15 and the sealing body 16 to secure the sealability in the battery case. The case main body 15 has an overhanging part 21 which is formed by, for example, pressing the side face part from outside and supports the sealing body 16. The overhanging part 21 is preferably formed into a ring shape along the circumferential direction of the case main body 15 and supports the sealing body 16 at the top side thereof.

The sealing body 16 has a structure in which the filter 22, a lower valve body 23, an insulating member 24, an upper valve body 25, and the cap 26 are laminated in this order from the side of the electrode assembly 14. Respective members included in the sealing body 16 have a disk shape or a ring shape, and respective members excluding the insulating member 24 are electrically connected to one another. The lower valve body 23 and the upper valve body 25 are connected to each other at the center thereof with the insulating member 24 interposed between the periphery parts thereof. Air vents are provided in the lower valve body 23, and therefore if the internal pressure of the battery increases due to abnormal heat generation, the upper valve body 25 expands on the side of the cap 26 and separates from the lower valve body 23, and the electrical connection between the two is thereby cut off. If the internal pressure further increases, the upper valve body 25 is broken and a gas is discharged from the opening of the cap 26.

Hereinafter, each of the components (positive electrode 11, negative electrode 12, and separator 13) of the electrode assembly 14, and the non-aqueous electrolyte will be described in detail.

[Positive Electrode]

The positive electrode 11 includes a positive electrode current collector 30 and a positive electrode mixture layer 31 formed on the collector. Foil of a metal, such as aluminum, that is stable in the electric potential range of the positive electrode 11, a film with such a metal disposed as an outer layer, and the like can be used for the positive electrode current collector. The positive electrode mixture layer 31 contains a positive electrode active material, an electrical conductor, and a binder. The positive electrode mixture layer 31 is generally formed on each side of the positive electrode current collector 30. The positive electrode 11 can be produced by, for example, applying a positive electrode mixture slurry containing the positive electrode active material, the electrical conductor, the binder, and the like on the positive electrode current collector 30, drying the resulting applying film, and rolling the resulting product to form the positive electrode mixture layer 31 on each side of the collector.

As the positive electrode active material, a lithium-containing transition metal oxide is preferably used. The metal element constituting the lithium-containing transition metal oxide is, for example, at least one selected from magnesium (Mg), aluminum (Al), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), yttrium (Y), zirconium (Zr), tin (Sn), antimony (Sb), tungsten (W), lead (Pb), and bismuth (Bi). The metal element preferably includes at least one selected from Co, Ni, Mn, and Al among others.

Examples of the electrical conductor constituting the positive electrode mixture layer 31 include carbon materials such as carbon black (CB), acetylene black (AB), Ketjenblack, and graphite. Examples of the binder constituting the positive electrode mixture layer 31 include fluororesins such as polytetrafluoroethylene (PTFE) and poly (vinylidene fluoride) (PVdF), polyacrylonitrile (PAN), polyimide resins, acrylic resins, and polyolefin resins. These may be used singly or in combinations of two or more thereof.

[Negative Electrode]

The negative electrode 12 is an electrode on which lithium metal is deposited during charging and has a negative electrode current collector 40. The lithium metal deposited on the negative electrode 12 is derived from lithium ions in the non-aqueous electrolyte, and the deposited lithium metal is dissolved into the electrolytic solution by discharging. The negative electrode 12 may include lithium metal, or may include, for example, lithium metal foil, or the negative electrode current collector 40 or a film having a lithium metal layer formed on the surface thereof by vapor deposition or the like (in this case, lithium is active material), and it is preferable that the negative electrode in an initial state does not have a negative electrode active material.

That is, the negative electrode preferably includes the negative electrode current collector 40 alone in the initial state. In this case, the volumetric energy density of the battery can be enhanced. In the case where a collector or the like having lithium metal foil or a lithium metal layer is used, the volumetric energy density of the battery is decreased by the amount corresponding to the thickness of the lithium layer. The initial state herein refers to a state of the non-aqueous electrolyte secondary battery 10 immediately after assembly (immediately after production) and means a state in which a battery reaction does not proceed.

The negative electrode current collector 40 includes, for example, foil of a metal such as copper, nickel, iron, stainless alloy (SUS), and among others, copper foil, which has a high electrical conductivity, is preferable. Copper foil is metal foil containing copper as a main component and may substantially include copper alone. The thickness of the copper foil is preferably 5 μm to 20 μm. The negative electrode 12 includes, for example, copper foil alone, having a thickness of 5 μm to 20 μm, before charging/discharging of the battery, and the lithium metal is deposited to form a lithium metal layer on each side of the copper foil by discharging. In the non-aqueous electrolyte secondary battery 10, lithium metal dendrites are unlikely to be produced and the lithium metal layer having a uniform thickness is formed on the surface of the negative electrode current collector 40 by the action of the lithium salt containing an oxalate complex as an anion, the lithium salt added in the non-aqueous electrolyte, so that the expansion of the negative electrode 12 is suppressed.

The negative electrode current collector 40 may have a layer (protective layer) containing a solid electrolyte, an organic substance, or an inorganic substance on the surface thereof. The protective layer has an effect of making the reaction at the electrode surface uniform to deposit the lithium metal uniformly on the negative electrode, so that the expansion of the negative electrode can be suppressed. Examples of the solid electrolyte include a sulfide solid electrolyte, a phosphoric acid solid electrolyte, a perovskite solid electrolyte, and a garnet solid electrolyte.

The above sulfide solid electrolyte is not particularly limited as long as it contains a sulfur component and has a lithium ion conductivity. Specific examples of the raw material for the sulfide solid electrolyte include a material containing Li, S, and a third component A. Examples of the third component A include at least one selected from the group consisting of P, Ge, B, Si, I, Al, Ga, and As. Specific examples of the sulfide solid electrolyte include Li₂S—P₂S₅, 70Li₂S—30P₂S₅, 80Li₂S—20P₂S₅, Li₂S—SiS₂, and LiGe_{0.25}P_{0.75}S₄.

The phosphoric acid solid electrolyte is not particularly limited as long as it contains a phosphoric acid component and has a lithium ion conductivity. Examples of the phosphoric acid solid electrolyte include Li₁₊ₓAlₓTi₂₋ₓ(PO₄)₃ (0<x<2, preferably 0<x≤1 among others.) such as Li_{1.5}Al_{0.5}Ti_{1.5}(PO₄)₃ and Li₁₊ₓAlₓGe₂₋ₓ(PO₄)₃ (0<x<2, preferably 0<x≤1 among others.).

Lithium-conductive substances such as polyethylene oxide and methyl polymethacrylate are preferable for the above organic substance layer. Ceramic materials such as SiO₂, Al₂O₃, and MgO are preferable for the inorganic substance layer.

[Separator]

An ion-permeable and insulating porous sheet is used as the separator 13. Specific examples of the porous sheet include a microporous thin film, woven fabric, and nonwoven fabric. Suitable examples of the material for the separator 13 include olefin resins such as polyethylene, polypropylene, and copolymers containing at least one of ethylene and propylene, and cellulose. The separator 13 may be a laminate including a cellulose fiber layer and a layer of fibers of a thermoplastic resin such as an olefin resin. The separator 13 may be a multi-layered separator including a polyethylene layer and a polypropylene layer, and a separator a surface of which is coated with an aramid resin or the like may also be used as the separator 13. In addition, a heat resistant layer containing an inorganic compound filler may be formed on at least one of interfaces between the separator 13 and the positive electrode 11 and between the separator 13 and the negative electrode 12.

[Non-Aqueous Electrolyte]

The non-aqueous electrolyte contains a non-aqueous solvent and an electrolyte salt dissolved in the non-aqueous solvent. The non-aqueous electrolyte contains, as described above, a lithium salt containing an oxalate complex as an anion. By adding the lithium salt to the non-aqueous solvent, the lithium metal dendrites are unlikely to be produced during charging, so that the expansion of the negative electrode 12 is suppressed. The lithium salt functions as an electrolyte salt but is decomposed at the negative electrode 12 to cause a decrease in concentration, and therefore it is preferable to use the lithium salt combined with another electrolyte salt. The non-aqueous electrolyte is not limited to a liquid electrolyte (non-aqueous electrolytic solution) and may be a solid electrolyte using a gel polymer or the like.

As the non-aqueous solvent, for example, esters, ethers, nitriles such as acetonitrile, amides such as dimethylformamide, and mixed solvents of two or more of these solvents can be used. The non-aqueous solvent may contain a halogen-substituted product formed by replacing at least part of hydrogen atoms of any of the above various solvents with a halogen atom such as fluorine.

Examples of the above esters include cyclic carbonate esters such as ethylene carbonate (EC), propylene carbonate (PC), butylene carbonate and fluoroethylene carbonate (FEC); chain carbonate esters such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylate esters such as γ-butyrolactone, and γ-valerolactone; and chain carboxylate esters such as methyl acetate, ethyl acetate, propyl acetate, methyl propionate (MP), ethyl propionate, γ-butyrolactone, and methyl fluoropropionate (FMP).

Examples of the above ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The lithium salt containing an oxalate complex as an anion is preferably contained in the non-aqueous electrolyte in a concentration of at least 0.01 M (mol/L). Addition of the lithium salt in a concentration of 0.01 M or more makes the effect of suppressing the expansion of the negative electrode 12 remarkable. The upper limit of the amount of the lithium salt to be added is preferably the solubility. The lithium salt is added as much as possible in a range where the deposition does not occur during the use of the battery.

The lithium salt containing an oxalate complex as an anion preferably contains boron (B) or phosphorus (P) and is, for example, at least one selected from lithium bis(oxalate)borate (LiBOB, LiB(C₂O₄)₂), LiBF₂(C₂O₄), LiPF₄(C₂O₄), and LiPF₂(C₂O₄)₂. Among others, LiBF₂(C₂O₄) is preferable. The preferred amount of the lithium salt to be added is different depending on the type of the solvent, and is, for example, about 0.2 M for LiBOB, about 1.0 M for LiBF₂(C₂O₄), and about 0.5 M for LiPF₂(C₂O₄)₂. The lithium salt is decomposed at the negative electrode 12, and therefore whether the lithium salt was added and the amount thereof added can be analyzed by analyzing a decomposed component of the lithium salt, for example, the composition of a film formed on the negative electrode 12

Examples of the electrolyte salt to be combined with the lithium salt containing an oxalate complex as an anion include LiBF₄, LiClO₄, LiPF₆, LiAsF₆, LiSbF₆, LiAlCl₄, LiSCN, LiCF₃SO₃, LiCF₃CO₂, and imide salts such as LiN(SO₂CF₃)₂ and LiN(CₗF₂ₗ₊₁SO₂)(CₘF₂ₘ₊₁SO₂) {where l and m are integers of 1 or more}. Among others, LiPF₆ is preferably used.

The non-aqueous electrolyte preferably contains another additive that is decomposed at the negative electrode 12. The non-aqueous electrolyte contains, for example, at least one selected from vinylene carbonate (VC), fluoroethylene carbonate (FEC), and vinyl ethyl carbonate (VEC). By adding VC or the like, the expansion of the negative electrode is further suppressed to make the cycle characteristics more favorable. It can be considered that this because a film derived from VC or the like having a low decomposition potential is formed on a film derived from the lithium salt containing an oxalate complex as an anion to stabilize the film stabilize.

### EXAMPLES

Hereinafter, the present disclosure will be described in more detail by way of Examples, but is not limited to these Examples.

### Example 1

[Production of Positive Electrode]

A lithium-containing transition metal oxide, as a positive electrode active material, containing aluminum, nickel, and cobalt, acetylene black (AB), and poly (vinylidene fluoride) (PVdF) were mixed in a mass ratio of 95:2.5:2.5, further, an appropriate amount of N-methyl-2-pyrrolidone (NMP) was added thereto, and the resultant was stirred, to thereby prepare a positive electrode mixture slurry. Subsequently, the positive electrode mixture slurry was applied on each side of the positive electrode current collector including aluminum foil, and the resulting applying film was dried. The applying film was rolled using a roller, and the resulting product was then cut into a predetermined size of an electrode to prepare a positive electrode in which a positive electrode mixture layer is formed on both sides of the positive electrode current collector in order.

[Production of Negative Electrode]

Electrolytic copper foil (thickness of 10 μm) was cut into a predetermined size of an electrode to use as a negative electrode. A negative electrode mixture was not applied on the copper foil.

[Preparation of Non-Aqueous Electrolytic Solution]

Ethylene carbonate (EC) and dimethyl carbonate (DMC) were mixed in a volume ratio of 3:7. LiPF₆ and LiBF₂(C₂O₄) were dissolved in the mixed solvent at a concentration of 1.0 M (mol/L) and 0.1 M (mol/L) respectively to prepare a non-aqueous electrolytic solution.

[Production of Battery]

In an inert gas atmosphere, the above positive electrode to which an aluminum tab was attached and the above negative electrode to which a nickel tab was attached were spirally wound through a polyethylene separator to produce a wound type electrode assembly. The electrode assembly was housed in an exterior body including aluminum laminate, the above non-aqueous electrolytic solution was injected thereinto, and the opening of the exterior body was then sealed to produce a battery T1.

### Example 2

A battery T2 was produced in the same manner as in Example 1, except that the amount of LiBF₂(C₂O₄) added was changed to 0.5 M (mol/L) in the preparation of the non-aqueous electrolytic solution.

### Example 3

A battery T3 was produced in the same manner as in Example 2, except that vinylene carbonate (VC) was added in an amount of 5 mass % based on the mass of the electrolytic solution in the preparation of the non-aqueous electrolytic solution.

### Example 4

A battery T4 was produced in the same manner as in Example 3, except that LiPF₆ was not added in the preparation of the non-aqueous electrolytic solution.

### Example 5

A battery T5 was produced in the same manner as in Example 3, except that LiBOB was added at a concentration of 0.1 M (mol/L) in place of LiBF₂(C₂O₄) in the preparation of the non-aqueous electrolytic solution.

### Example 6

A battery T6 was produced in the same manner as in Example 3, except that LiPF₂(C₂O₄)₂ was added at a concentration of 0.5 M (mol/L) in place of LiBF₂(C₂O₄) in the preparation of the non-aqueous electrolytic solution.

### Comparative Example 1

A battery R1 was produced in the same manner as in Example 1, except that LiBF₂(C₂O₄) was not added in the preparation of the non-aqueous electrolytic solution.

### Comparative Example 2

A battery R2 was produced in the same manner as in Example 3, except that LiBF₂(C₂O₄) was not added in the preparation of the non-aqueous electrolytic solution.

Evaluation of the negative electrode expansion rate and evaluation of dendrites at the surface of the negative electrode were performed by the following methods for each of the batteries of Examples and Comparative Examples.

[Evaluation of Negative Electrode Expansion Rate]

The negative electrode expansion rate with respect to Li true density was determined for each battery in a charged state by the following procedure. The evaluation results are shown in Table 1.

(1) Charging Condition: A constant current charging was carried out at a current of 0.1It to a battery voltage of 4.3 V, and a constant voltage charging was then carried out at a constant voltage of 4.3 V to a current of 0.01It.
(2) Amount of Negative Electrode Expansion: The battery in a charged state was disassembled, and the thickness of the negative electrode was measured in a secondary electron image (SEM image) of a section of the negative electrode. The amount of negative electrode expansion was calculated by subtracting the thickness of the negative electrode before charging from the measured thickness of the negative electrode.
(3) Thickness of Li Metal with Respect to Charge Capacity: From the charge capacity obtained by the above charging, the thickness of the negative electrode in the case where the deposited layer on the surface of the negative electrode was assumed to be Li metal of true density was determined by calculation assuming that the theoretical capacity is 3860 mAh/g, and the true density of Li metal is 0.534 g/cm³ (room temperature).
(4) Calculation of Negative Electrode Expansion Rate with Respect to Li True Density: The negative electrode expansion rate with respect to the Li true density was determined by the following expression.

Negative electrode expansion rate of (2)/thickness of Li metal layer of (3)×100(%) (Expression 1)

[Evaluation of Dendrites at Surface of Negative Electrode]

The surface of the negative electrode obtained by disassembly in (2) was observed by a secondary electron image to check whether needle-like dendrites exist or not. The evaluation results are shown in Table 1.

TABLE 1

| | | | | | Negative | |
|---|---|---|---|---|---|---|
| | Oxalate salt | | | | electrode | |
| | Compo- | Concen- | | | expansion | |
| | sition | tration | LiPF₆ | VC | rate | Dendrites |
| T1 | LiBF₂(C₂O₄) | 0.1M | 1M | — | 1.45 times | Not produced |
| T2 | LiBF₂(C₂O₄) | 0.5M | 1M | — | 1.34 times | Not produced |
| T3 | LiBF₂(C₂O₄) | 0.5M | 1M | 5 mass % | 1.31 times | Not produced |
| T4 | LiBF₂(C₂O₄) | 0.5M | — | 5 mass % | 1.42 times | Not produced |
| T5 | LiBOB | 0.1M | 1M | 5 mass % | 1.50 times | Not produced |
| T6 | LiPF₂(C₂O₄)₂ | 0.5M | 1M | 5 mass % | 1.48 times | Not produced |
| R1 | — | — | 1M | — | 2.35 times | Produced |
| R2 | — | — | 1M | 5 mass % | 2.12 times | Produced |

As shown in Table 1, in any of the batteries of Examples, the negative electrode expansion rate was low, compared to the batteries of Comparative Examples, and production of the dendrites was not confirmed. That is, the lithium metal dendrites are unlikely to be produced during charging and the expansion of the negative electrode is suppressed specifically by adding an oxalate complex to a non-aqueous electrolytic solution. In addition, the effect of suppressing the expansion of the negative electrode is more remarkable by combining the lithium salt, LiPF₆, and VC for use.

### Example 7

A battery T7 was produced in the same manner as in Example 3, except that the amount of LiBF₂(C₂O₄) added was changed to 0.01 M (mol/L) in the preparation of the non-aqueous electrolytic solution.

### Example 8

A battery T8 was produced in the same manner as in Example 3, except that the amount of LiBF₂(C₂O₄) added was changed to 0.1 M (mol/L) in the preparation of the non-aqueous electrolytic solution.

### Example 9

A battery T9 was produced in the same manner as in Example 3, except that the amount of LiBF₂(C₂O₄) added was changed to 1 M (mol/L) in the preparation of the non-aqueous electrolytic solution.

### Example 10

A battery T10 was produced in the same manner as in Example 3, except that the amount of LiBF₂(C₂O₄) added was changed to 2M (mol/L) in the preparation of the non-aqueous electrolytic solution. However, in this case, LiBF₂(C₂O₄) was not dissolved completely, and therefore the battery T10 was produced using a suspension containing insoluble matter of LiBF₂(C₂O₄).

Evaluation of the negative electrode expansion rate and evaluation of dendrites at the surface of the negative electrode were performed for the batteries T7 to T10, and the evaluation results are shown in Table 2 (evaluation results of batteries T3 and R2 are shown together).

TABLE 2

| | | | | | Negative | |
|---|---|---|---|---|---|---|
| | Oxalate salt | | | | electrode | |
| | Compo- | Concen- | | | expansion | |
| | sition | tration | LiPF₆ | VC | rate | Dendrites |
| T7 | LiBF₂(C₂O₄) | 0.01M | 1M | 5 mass % | 1.71 times | Not |
| | | | | | | produced |
| T8 | LiBF₂(C₂O₄) | 0.1M | 1M | 5 mass % | 1.45 times | Not |
| | | | | | | produced |
| T3 | LiBF₂(C₂O₄) | 0.5M | 1M | 5 mass % | 1.31 times | Not |
| | | | | | | produced |
| T9 | LiBF₂(C₂O₄) | 1M | 1M | 5 mass % | 1.29 times | Not |
| | | | | | | produced |
| T10 | LiBF₂(C₂O₄) | 2M* | 1M | 5 mass % | 1.25 times | Not |
| | | | | | | produced |
| R2 | — | — | 1M | 5 mass % | 2.12 times | Produced |

*Insoluble matter exists

As shown in Table 2, reduction in the negative electrode expansion rate by addition of LiBF₂(C₂O₄) at a concentration of 0.01 M or more has been confirmed. The effect was higher when the concentration of LiBF₂(C₂O₄) was higher, and the effect of suppressing the expansion was particularly remarkable at concentrations of 0.5 M or more. It is preferable that the amount of addition of the lithium salt containing an oxalate complex as an anion is set to be the maximum amount of the lithium salt that can be dissolved in a solvent. In the solvents used in the present Examples, LiBF₂(C₂O₄) was not dissolved completely at a concentration of 2 M, but if other solvents are used, there is a possibility that LiBF₂(C₂O₄) dissolves completely at a concentration of 2 M.

### Example 11

A film of a protective layer including lithium phosphate and having a thickness of 5 μm was formed using trimethyl phosphate and lithium (bistrimethylsilyl) amide as raw materials on the surface of the negative electrode current collector by an ALD method (Atomic Layer Deposition method). A battery T11 was produced in the same manner as in Example 3, except that this negative electrode current collector was used. When the negative electrode expansion rate of T11 with respect to the Li true density was calculated, the thickness of lithium phosphate was not taken into consideration.

TABLE 3

| | Oxalate salt | | | | | Negative electrode | |
|---|---|---|---|---|---|---|---|
| | Composition | Concentration | LiPF₆ | VC | Protective layer | expansion rate | Dendrites |
| T11 | LiBF₂(C₂O₄) | 0.5M | 1M | 5 mass % | Lithium phosphate | 1.20 times | Not produced |
| T3 | LiBF₂(C₂O₄) | 0.5M | 1M | 5 mass % | None | 1.31 times | Not produced |

As shown in Table 3, the negative electrode expansion rate was further reduced by forming a protective layer composed of lithium phosphate on the surface of the negative electrode current collector.

### REFERENCE SIGNS LIST

10 non-aqueous electrolyte secondary battery
11 positive electrode
12 negative electrode
13 separator
14 electrode assembly
15 case main body
16 sealing body
17, 18 insulating plate
19 positive electrode lead
20 negative electrode lead
21 overhanging part
22 filter
23 lower valve body
24 insulating member
25 upper valve body
26 cap
27 gasket
30 positive electrode current collector
31 positive electrode mixture layer
40 negative electrode current collector

1. A non-aqueous electrolyte secondary battery comprising:
a positive electrode having a positive electrode current collector and a positive electrode mixture layer formed on the collector;
a negative electrode having a negative electrode current collector; and
a non-aqueous electrolyte, wherein
a lithium metal is deposited on the negative electrode current collector during charging and the lithium metal is dissolved into the non-aqueous electrolyte during discharging, and wherein
the non-aqueous electrolyte contains a lithium salt containing an oxalate complex as an anion.

2. The non-aqueous electrolyte secondary battery according to claim 1, wherein the negative electrode in an initial state does not have a negative electrode active material.

3. The non-aqueous electrolyte secondary battery according to claim 1, wherein the negative electrode current collector is copper foil.

4. The non-aqueous electrolyte secondary battery according to claim 1, wherein the non-aqueous electrolyte further contains lithium hexafluorophosphate.

5. The non-aqueous electrolyte secondary battery according to claim 1, wherein the non-aqueous electrolyte further contains at least one selected from vinylene carbonate, fluoroethylene carbonate, and vinyl ethylene carbonate.

6. The non-aqueous electrolyte secondary battery according to claim 1, wherein the lithium salt containing an oxalate complex as an anion is contained at a concentration of at least 0.01 M in the non-aqueous electrolyte.

7. The non-aqueous electrolyte secondary battery according to claim 1, wherein the lithium salt containing an oxalate complex as an anion contains boron or phosphorus.

8. The non-aqueous electrolyte secondary battery according to claim 1, wherein a layer containing at least one selected from solid electrolytes, organic substances, and inorganic substances is provided on a surface of the negative electrode current collector.

9. The non-aqueous electrolyte secondary battery according claim 1, wherein an electrolyte salt to be combined with the lithium salt includes LiBF₄, LiClO₄, LiPF₆, LiAsF₆, LiSbF₆, LiAlCl₄, LiSCN, LiCF₃SO₃, LiCF₃CO₂, and imide salts including LiN(SO₂CF₃)₂ and LiN(CₗF₂ₗ₊₁SO₂)(CₘF₂ₘ₊₁SO₂), where l and m are integers of 1 or more.

10. The non-aqueous electrolyte secondary battery according claim 1, wherein an electrolyte salt to be combined with the lithium salt is LiPF₆.
